(19) United States
(12) Patent Application Publication
(10) Pub. No.: US 2018/0276625 A1
(43) Pub. Date: Sep. 27, 2018

(54) Contract ratification by automated agents through distributed ledger technology

(71) Applicants: Justin Saye, Ventura, CA (US); Kevin Saitta, Issaquah, WA (US)

(72) Inventors: Justin Saye, Ventura, CA (US); Kevin Saitta, Issaquah, WA (US)

(21) Appl. No.: 15/469,948

(22) Filed: Mar. 27, 2017

(51) Int. Cl. G06Q 20/02; G06Q 20/38

(52) U.S. Cl. CPC G06Q 20/023; G06Q 2220/00; G06Q 20/3829

(57) ABSTRACT

The present invention relates to a method and a computerized process for automated agents (software-only through e-commerce channels, software-controlled transport such as drones and autonomous vehicles, software-based through handheld devices such as smartphones and remote terminals), which ratify contracts on behalf of principals for transfer of goods and services. This method and computerized process is embodied by software that can be used to access brokered contract parameter data, as available in distributed ledger protocols, to establish trusted relationships and workflow steps between software-based agents (artificial intelligence or otherwise algorithmically-derived). It should be further noted that software agents will send and receive workflow instructions and status to a server entity for reconciliation and exception handling.

### BACKGROUND OF THE INVENTION

### 1. Field of the Invention

The present invention relates generally to Contract ratification by automated agents through distributed ledger technology.

### 2. Background

Currently, there are many solutions for contract ratification through software and digital means. Some of these solutions attempt to make contract ratification easier and more efficient for principals, but these solutions fail to meet the needs of the industry because they are still reliant on the transmission of fully formed contract provisions and principal authorization at each transfer point. Other solutions attempt to proxy automation of contract ratification, but these solutions are similarly unable to meet the needs of the industry because they continue to rely on a fully-documented and countersigned paper trail of artifacts. Still, other solutions seek to minimize documentation through workflow and third-party payment clearance mechanisms, but these solutions also fail to meet industry needs because they require standing business relationships between all principals and agents on a unilateral, bilateral basis. It would be desirable to have a software process for contract ratification by automated agents that will increase automation of product and service transfer of value by enabling trusted Software Agents to broker the transfer of contract value through an internet-based distributed ledger protocol (such as blockchain). Furthermore, it would also be desirable to have an automated process (through computing mechanisms) that will remove transaction costs of goods and services movement by reducing contractual negotiation and trust verification to the exchange of several bytes of data. Still further, it would be desirable to have a computerized process for automated contract modification that will reduce transportation and labor costs related to misdirected goods and services through automated rerouting of contractual commitments via trusted distributed ledger networks. Therefore, there currently exists a need in the industry for a process that allows automated agents to ratify contracts through a distributed ledger technology.

### SUMMARY OF THE INVENTION

The present invention advantageously fills the deficiencies mentioned above by providing contract ratification by automated agents through a decentralized distributed ledger technology, which provides a software method and process for conveying chain of custody and value between Software Agents (executable programs) on behalf of principals.

The present invention is for an automated, computerized software process for contract ratification by automated agents utilizing a decentralized distributed ledger technology by leveraging committed logging technology (software methods for ensuring survivability of log messages in the event of connectivity loss) for guaranteed delivery. This process is made up of the following executable steps, all of which are required in all versions:
1. Invention maintains contract broker logic utilizing a decentralized node (server) or node (server) clusters.
2. Principal enters contract parameters and assigned committed workflow into an Internet-enabled Graphic User Interface (GUI) or desktop application Graphic User Interface (GUI) or Application Programming Interface (API).
3. Nodes and agents maintain read and write connectivity through standard communications protocols to any decentralized distributed ledger protocol utilizing distributed committed logging technology for guaranteed delivery of payload.
4. Agent software is deployed to any digital rendering device or interface, either as a standalone application or as a reference library of software instructions, such as a Software Development Kit, used by other software.
5. Agent software maintains workflow and status communication lines via available communication networks and protocols with the node or node cluster leveraging committed logging technology for guaranteed delivery of information.
6. Commit log technology and nodes maintain secure chain of custody and committed workflow of contract provisions through a distributed ledger technology, such as blockchain, by writing an encoded transaction record to the ledger and recording a unique private key.
7. Agent software receives and processes the private key, contract parameters and committed workflow upon request from nodes and committed logging technology for guaranteed delivery.
8. Agent software, in the course of executing a committed workflow per instruction set, establishes communication threads, through available networks and protocols, with other authorized agents autonomously or under direction from other software or persons (instruction interrupt through device or system User Interface).
9. Agent software on communication threads reconcile committed workflow and contract parameters against existing committed workflow and job catalog of agent.
10. Agent software communicates with committed logging technology and nodes, leveraging software actors (such as service daemons) to reconcile exceptions and changes to existing instruction sets and parameter values.
11. Agent software on communication threads ratify the contract for the exchange of value through authentication, acknowledgment and accounting protocols (transfer of the private key between identified agents) and commit write to distributed ledger technology leveraging committed logging technology for guaranteed payload delivery.
12. Agent software executes committed workflow and submits status updates to committed logging technology for guaranteed delivery to decentralized nodes or node clusters.
13. Nodes read and reconcile changes to workflow with changes to distributed ledger and communicate status to principal through server User interface or Application Programming Interface (API).
14. Agent software submits performance, exception and status data to listening actors for delivery to committed logging technology for guaranteed delivery to decentralized node or node clusters for continual improvement.

The present invention may also have one or more of the following optional executable steps:
1. Software agents and nodes may request manual intervention from principal to reconcile conflicts in automated ratification process.
2. Software agents and nodes may interface with electronic signature software applications for documentation purposes.
3. Software agents and nodes may handle complete workflow with the communication protocol and accounting technologies other than distributed ledger technology, but that serve the same purpose as a dynamic, key-paired, robust, automated, and distributed trust store.
4. Software agents may extend write commit to distributed ledger beyond contract parameters to include workflow instructions, pricing thresholds, and alternative value clearance methods.

The software of the present invention is unique when compared with other known solutions in that it provides automated decision-making and workflow between authorized agents to allow for the autonomous transfer of value, based upon trusted data stores (distributed ledger technology), distributed commit logs and principal-mandated contractual parameters. There are no current solutions in the market that are comparable or substitutive, except for traditional manually-derived contract ratification processes or proxies. The software of this invention presents a decision layer for autonomous-software controlled devices to execute complex and intermediated workflows without the need for manual intervention. For example, this invention provides for a scenario whereby a package delivery drone could cross-dock transfer a package to another package delivery drone for final delivery without manual intervention, pre-existing instructions or synchronous communications with control nodes, saving cost through wasted energy and time and assuring legal chain of custody.

The present invention software is unique when compared with other software solutions in that it incorporates distributed ledger technology protocols, distributed committed logging technology for guaranteed delivery and autonomous software agents to execute contract parameters for the transfer of value through autonomous contract ratification. The present invention software is an autonomous method of contract ratification that provides a complete solution for autonomous exchange of value that can be referenced by any other software platform to complete a limitless potential of workflows that require real time, near real time or batch autonomous and contractually-binding decision-making and agents.

In addition, it is an object of the present invention to provide contract ratification by automated agents through distributed committed logging technology and distributed ledger technology that does not suffer from any of the problems or deficiencies associated with prior solutions, such as manual errors, time delays or lost contracts.

It is still further an object of the present invention to allow autonomous devices to transfer chain of custody of carried articles (packages) legally without human oversight and independent of human intervention in the pursuit of delivery of the articles to their final destination.

Further still, it is an object of the present invention to allow autonomous software agents to authorize discrete scopes of services to one or many other autonomous software agents that have a monetary or other asset value.

Further still, it is an object of the present invention to allow autonomous software agents to initiate or deny discrete scopes of services to one or many other autonomous software agents that have a monetary or other asset value.

Further still, it is an object of the present invention to allow autonomous software agents to autonomously-organize discrete asset transfer or scopes of services among one or many other software agents that have a monetary or other asset value in the pursuit of completing a higher-level instruction.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 shows the initial write of the contract parameters to the distributed ledger technology and propagation to software agents, referencing a software library.

FIG. 2 shows the decision-making workflow.

FIG. 3 shows the ratification of the contract between software agents.

FIG. 4 shows the completion of the contracted workflow between software agents.

### DETAILED DESCRIPTION OF THE INVENTION

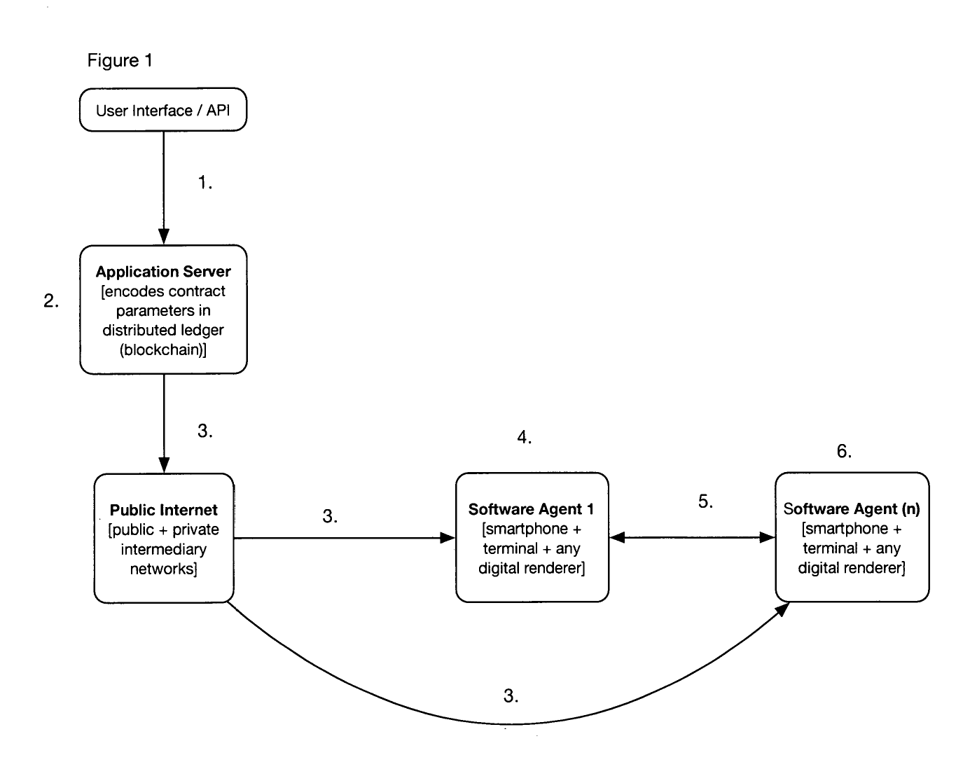

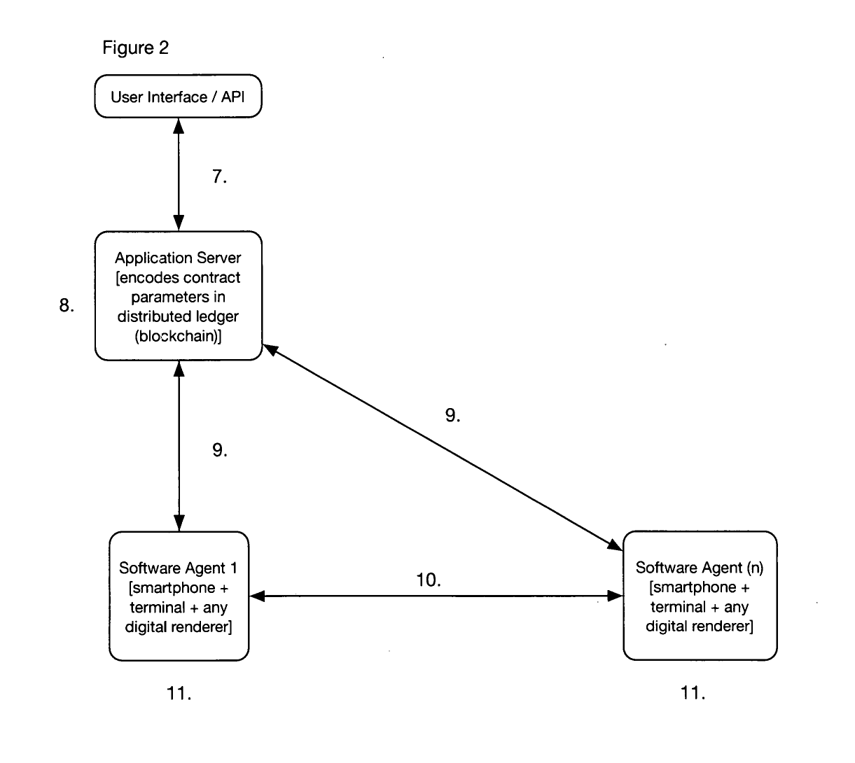

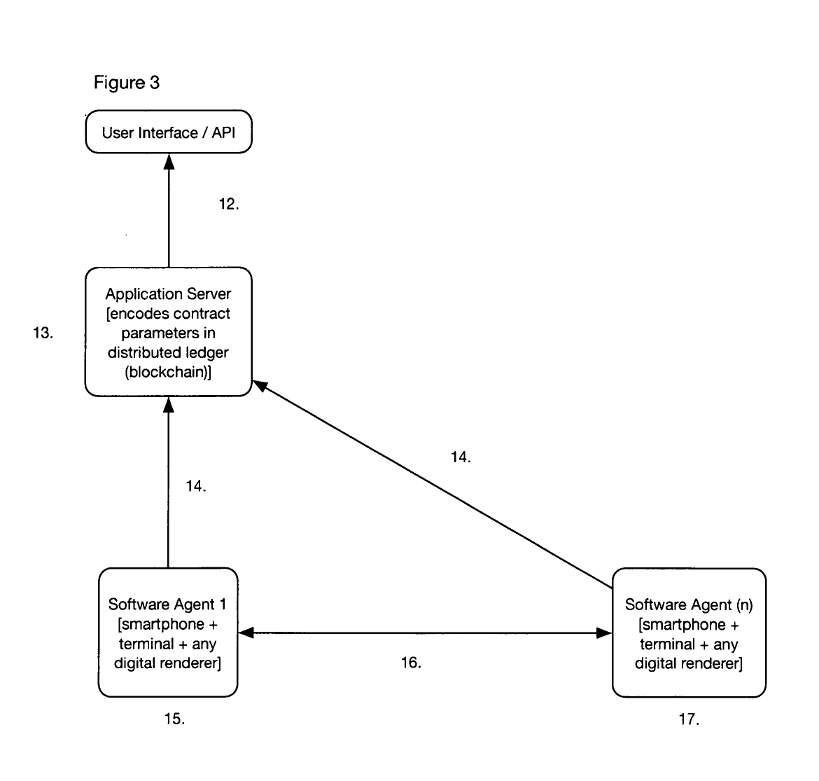

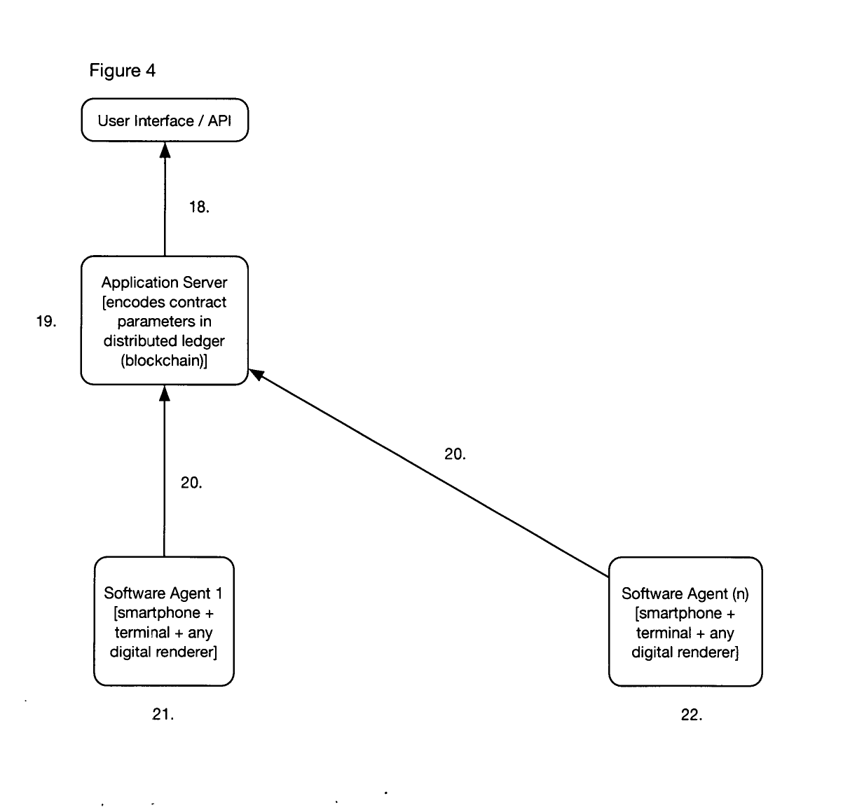

The present invention is directed to contract ratification by automated agents through distributed ledger technology. In its most complete and preferred version, the software is made up of the following executable steps:
1. As indicated in FIG. 1, a User Interface or Application Programming Interface is available for a principal to input prescribed contract information via commonly available software code and protocols. This information is transmitted 1 into the Application Server (node) within the context of an authenticated and secure session state for the principal.
2. As directed by a compiled software code library, the contract information (principal, value, payment value store, work proposed, clearance criteria, among others) is parsed into discrete, stateless parameter key-value pairs which are written to a message queue handler with a committed logging feature along with a two-part hash authorization key (Initiator and Acceptor) 2. As directed by a compiled software code library, the key-value pairs, within a queued message format, are processed through a workflow processing logic that allocates the contract parameter values to individual workflow steps in line with any job processing algorithm, as described in the compiled software code libraries.
3. As directed by a compiled software code library, the workflow steps as attributed to associated contract parameter values are then encoded in a distributed ledger protocol by the message queue consumer application and published 3 in accordance with distributed ledger protocols.
4. Software Agent (1) client application on digital rendering devices (e.g., smartphone, smartwatch, personal computer, embedded processor, terminal) with distributed ledger read/write capability will receive distributed ledger data via any Internet protocol and workflow notification from the Application Server 4.
5. As directed by the compiled software code library:
   a. Workflow logic will be processed by the agent client application
   b. Library logic will authenticate workflow steps
   c. Library logic will make a decision to accept or reject workflow steps, subject to environmental, temporal, value, charter, and other variable parameters.
      i. If rejected, Software Agent will ignore workflow step and listen for next.
      ii. If accepted, Software Agent will write acceptance to distributed ledger technology and await connection from Software Agent (n).
6. Based upon location data received from the Application Server or from Software Agent (n), Software Agent (1) will seek, via broadcast message on any communications protocol, a connection with Software Agent (n) and initiate a secure data transmission session through standard Authentication, Acknowledgement and Accounting protocols with or without strong encryption 5 and transfer private key.
7. Software Agent (n) client application on digital rendering devices (e.g., smartphone, smartwatch, personal computer, embedded processor, terminal) with distributed ledger read/write capability will receive distributed ledger data via any Internet protocol and workflow notification from the Application Server 3.
8. As directed by the compiled software code library:
   a. Workflow logic will be processed by the agent client application
   b. Library logic will authenticate workflow steps
   c. Library logic will make a decision to accept or reject workflow steps, subject to environmental, temporal, value, charter, and other variable parameters 6.
      i. If rejected, Software Agent will ignore workflow step, return private key, and listen for next.
      ii. If accepted, Software Agent will write acceptance to distributed ledger technology and await connection from Software Agent (n).
9. As indicated in FIG. 2, decision making logic is brokered and managed among the Software Agents and Application Server. Subject to feedback received from the 1+n Software Agents, the Application Server, via the message queue handler, renders workflow status and contract parameter change options on the User Interface and/or otherwise makes available for query from the Application Programming Interface 7.
10. In the case of exception handing (workflow variance) between Software Agents, and as directed by the compiled software code library:
   a. Software Agent (1) and Software Agent (n) will compare workflow steps to state table of variable values and thresholds (environmental, temporal, value, charter, and other variables).
   b. Software Agent (1) and Software Agent (n) will calculate the variance delta and write to a data serialization protocol (in standard human readable or binary formats).
   c. Variance delta will be transmitted between the parties 10.
   d. Each Software Agent will compare the variance against variable thresholds and workflow guidelines to determine feasibility of variance 11.
   e. If variance is tolerable, Software Agents will, through standard communication protocols:
      i. Acknowledge, Authorize, Account for the variance with a write to a data serialization protocol 10.
      ii. Initiating Software Agent will write and/or modify workflow steps to new variance.
      iii. Initiating Software Agent will submit variance workflow to the Application Server 9.
   f. If variance is not tolerable, Software Agents will, through standard communication protocols:
      i. Place workflow in a hold queue 11.
      ii. Submit variance workflow to the Application Server 9.
      iii. Transfer private key to Application Server 9.
      iv. Request contract parameter change authorization from Application Server 9.
11. Subject to principal preference, contract parameter change options are approved manually and transmitted or processed within the broad instruction set first made available to the compiled software code library through the User Interface or Application Program Interface 12.
12. As directed by the software code library:
   a. Contract parameter changes are processed into the existing workflow and left in an open state for acknowledgement by Software Agents party to the contract 8.
   b. Workflow step and contract parameter value changes, as attributed to root associated contract parameter values, are then encoded in a distributed ledger protocol by the Application Server 8 and published in accordance with distributed ledger protocols.
   c. Application Server transfers private key to Software Agent 1.
13. As indicated in FIG. 3, once contract parameter values have been verified and accepted between the Software Agents, status is rendered through the User Interface or made available through the Application Program Interface 122.
14. As directed by the compiled software code library:
   a. Software Agent (1) writes a concatenated hexadecimal code of distributed ledger transaction value and “Initiator” hash value 15.
   b. Software Agent (n) writes a concatenated hexadecimal code of distributed ledger transaction value and “Acceptor” hash value 17.
   c. Software Agent (n) submits Acceptor to Software Agent 1 through common Authentication, Acknowledgement and Accounting protocols 16.
   d. Software Agent (1) ratifies contract value exchange and write/commits to Distributed Ledger 15.
   e. Software Agent (1) submits Initiator and Software Agent n submits Acceptor values to Application Server 14.
15. Application Server, via message queue handler, updates workflow 13 and makes status available via User Interface or Application Program Interface 12.
16. As indicated in FIG. 4, once contract and any changes have been ratified between the agents, the Application Server updates all database records 19 and renders new estimates for completion and status to the User Interface and Application Program Interface 18.
17. Software Agent (1) completes committed workflow 21 and submits status to the Application Server 20.
18. Software Agent (n) completes committed workflow 22 and submits status to the Application Server 20.
19. Application Server, via message queue handler, processes workflow status messages from Software Agents and renders to User Interface or makes available via Application Program Interface 19.
20. Upon completion of workflow, Application Server submits receipt of workflow completion, distributed ledger record and recorded authorizations to payment clearing house 19.
21. Upon receipt of payment clearance, Application Server closes the transaction and records accounting data in database 19.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed ii intended that the scope of the invention should be determined by proper interpretation and construction of the appended claims and their legal equivalents, as understood by those of skill in the art relying upon the disclosure in this specification and the attached drawings.

What is claimed is:

1. A software method comprising the steps of encoding contract authorization parameters in a distributed ledger protocol, encoding the unique legal description of articles of value and final disposition of such articles, encoding the authorization protocol for ratification of transfer of value of such articles, a container for algorithm-based decision handling for the transfer of value, and encoding the ratification of transfer of value of such articles in a distributed ledger protocol for the creation and fungibility of public and private keys.

2. The method of claim 1 additionally comprising encoding logic to write contract parameters as metadata within a distributed ledger protocol address message.

3. The method of claim 1 additionally comprising decoding logic to read contract parameters from metadata within a distributed ledger protocol address message.

4. The method of claim 1 additionally comprising a distributed hash table of approved software agent addresses for distributed ledger addressing.

5. The method of claim 1 additionally comprising a distributed hash lookup service available to known and unknown software agents for distributed ledger address resolution and validation.

6. The method of claim 1 additionally comprising a software container for algorithm library services for ratification of transfer of value of articles under custody.

7. The method of claim 1 additionally comprising a distributed hash lookup service available to known and unknown software agents for authorized algorithm libraries.

8. The method of claim 1 wherein message handling commit write logic to nodes is handled by a message queue handler with committed logging features.

9. The method of claim 1 additionally comprising encoding tolerance values for routing and handling variance thresholds within the distributed ledger message.
